(19) United States
(12) Patent Application Publication
(10) Pub. No.: US 2025/0291896 A1
(43) Pub. Date: Sep. 18, 2025

(54) METHOD AND SYSTEM FOR ANALYZING EMBEDDED SYSTEMS

(71) Applicant: ObjectSecurity LLC, San Diego, CA (US)

(72) Inventors: Ulrich LANG, SR., San Diego, CA (US); Reza FATAHI, Encino, CA (US); Holmes CHUANG, Las Vegas, NV (US); Drew YENZER, Kirkland, WA (US)

(73) Assignee: ObjectSecurity LLC, San Diego, CA (US)

(21) Appl. No.: 18/607,189

(22) Filed: Mar. 15, 2024

(51) Int. Cl. G06F 21/54; G06F 21/57

(52) U.S. Cl. CPC G06F 21/54; G06F 21/577

(57) ABSTRACT

Method and system for analyzing software or firmware of computing systems to assess security properties includes loading predicate device input data including characteristics about predicate devices; translating predicate device input data into predicate device model data describing characteristics or dependencies of the predicate device input data relevant to the analysis; determining digital twin configuration data used to configure digital twin; loading the digital twin configuration data onto the digital twin; storing configuration data in the memory; instructing the digital twin to configure itself to implement the loaded digital twin configuration data; determining security analysis to be carried out on the digital twin; simulating the predicate device; executing security analysis on the digital twin; generating output data describing the result of execution of the security analysis; storing output data pertaining to the result; and determining if the result satisfies a predetermined condition, and if so, executing action corresponding to the result.

This application claims priority to U.S. Provisional Application No. 63/452,400 entitled “Method and System for Analyzing Embedded Systems”, which was filed on Mar. 15, 2023, and which is incorporated herein by reference.

This invention was made with government support under W56HZV-22-C-0030 awarded by United States Army. The government has certain rights in the invention.

### BACKGROUND OF THE INVENTION

### 1. Field of the Invention

This invention relates to a novel method and system of dynamic analysis with digital twin representations of embedded systems, running a combination of programmable hardware (e.g., FPGA) and software components. The invention facilitates the dynamic creation of digital twin representations, acquiring and/or modifying binary samples, rehosting binary samples, simulating programs resulting from binary samples, and dynamic assessments of samples and/or programs running on digital twin representations of embedded devices that apply to various domains including, but not limited to, vehicular Electronic Control Units (ECUs) and Operational Technologies in Industrial Control Systems (OT/ICS). An example of the invention comprises templates of components for rapid prototyping and automates the memory mapping and peripherals configurations of hosted Field Programmable Gate Arrays (FPGA) systems, resulting in a library of embedded devices via a fully abstracted hardware backend away from end users, thus, providing them the requested and necessary software-only experience.

Disclosed is a computer-implemented method for analyzing software and firmware in computing systems, focusing on security properties, rehosting capabilities, and enhanced observability. The method includes loading predicate device input data, translating it into a model, configuring a digital twin environment for security analysis, and executing said analysis. Additionally, the method involves receiving a binary file of arbitrary architecture, disassembling and processing it probabilistic and statistical techniques including AI/ML for improved disassembly and decompilation, and rehosting the compiled program on specialized hardware with advanced introspection capabilities. This facilitates dynamic analysis, including fuzzing and vulnerability assessment, with results presented in various adaptable forms. The methods leverage processors and specialized hardware components, incorporating statistical, probabilistic processing, and enhanced observability features, introducing advancements to the art that significantly enhance the analysis and security of software and firmware in diverse computing environments.

### 2. Description of the Related Art

### Digital Twins

Digital twin systems play an important role in the logical and physical modeling of embedded devices for analysis and simulation in various domains of computer-related research. In particular, in vulnerabilities research, a subdomain of cybersecurity, digital twins unlock new capabilities in dynamic analysis of software programs. For example, modern vehicles are comprised of many separate embedded devices orchestrated by one or more ECUs. An ECU is responsible for running the operations of connected devices to realize a broad range of functionalities that include sensor feedback and computer-aided safety features such as control of brakes and steering. However, adversaries may exploit weaknesses and vulnerabilities of ECUs to control vehicles and cause disastrous cyber/physical outcomes. With the current structure and organization of ECUs, attacks may occur at various layers of operation. For example, an attack may happen remotely via automotive networks and physically by interfering with the electronics. A digital twin may be used in this scenario to run and simulate programs for the discovery, and subsequent mitigation, of such attacks, by identifying facets related to input, state, and affected regions of a system and/or program.

### Simulation and Emulation

Conventional approaches are not fully-automated and are limited in their ability to host reliable dynamic assessments. The existing software-only simulations available in the conventional state-of-the-art do not support high-fidelity simulations of cyber-physical systems that often require specific hardware and software configurations. Ultimately, conventional Central Processing Unit (CPU)-based digital twin systems are inherently limited in their ability to provide insight at the level of individual circuits that are operating or affected under attack, prompting a risk/benefits consideration scenario with respect to analyzing original systems. Therefore, these CPU-based analyses are insufficient due to the limitations of observability. Exacerbating these limitations, software-only emulations like QEMU often face challenges due to artifacts arising from hosting programs across different architectures, primarily due to a lack of emphasis on observability and reliability of state characteristics in virtualized environments.

In this manner, the findings with respect to vulnerability analysis, especially dynamic analysis of host environments including the capture of physical emulations and/or responses that may be observed and analyzed as signals (i.e., physical modeling), are not reliable or highly accurate in a cross-architectural software simulation. Additionally, observability will always be limited to the Joint Test Action Group (JTAG) standard at its lowest resolution on CPU-based systems, and there would not be any significant benefits in the insight to internal processes of a successful simulation with this approach.

These limitations to observability of conventional CPU-based digital twin systems are a potential detriment to the long-term utility and success of detecting and deterring attacks against critical infrastructure. In contrast, FPGA-based systems offer enhanced capabilities for tracking, tracing, and observing operations at the granular level of individual circuits and modules, including caches and memory, without the limitations faced by CPU-based methods. With FPGA, achieving these capabilities relates to building observability Intellectual Property (IP) cores for enhanced insight to the internal workings of the digital twin and system under test. The hard limitation of CPU-based systems on JTAG as the lowest level of resolution bars significant advancements from being able to achieve long-term benefits and objectives.

### Automotive Cybersecurity

For automotive cybersecurity, a specific use case of embedded device security, the conventional current approaches to detect and test vulnerabilities in ECUs are limited in scope and ability. They consist of disparate tools that must be tested independently, each focusing on one or few areas of detection that are primarily targeting controller area network (CAN) bus fuzzing, interruptions, and injections. More recently, side channel attacks (SCAs) have emerged as a new threat vector against ECUs, capable of breaking encryption and disrupting automotive processes. These SCAs are several orders of magnitude more effective than mathematical modeling attacks and are more practical to mount by less sophisticated adversaries. They may lead to inefficient operations such as in a timing attack that results in greater power consumption, the detection and breaking of encryption algorithms such as by electromagnetic (EM) characterization, and disruptions of operations such as by radio jamming and power glitching methods.

Among all scenarios of attacks, there is a measurable outcome in the operations of an ECU at multiple layers, namely: at the physical layer where EM emanations exist, at the pin and/or sub-systems layer where raw signals are transmitted in an automotive network, and at the operational layer where encoded packets exist. Therefore, there is a need to characterize cyber-physical systems such as ECUs in their digital and physical representations to distinguish normal from abnormal conditions.

There exist practical difficulties in simulating and studying automotive systems. The testing is challenged by the need to interface automotive components of ECUs such as networks, sensors, and multiple ECUs. These often require manual expertise to rewire and configure systems, each iteration is time-consuming and may require physical diagnosis and mitigation strategies to succeed. Another aspect is the resource availability of reference devices, and twins overcome these limits and enable teams and/or systems to analyze and run devices continuously, in parallel, at scale, etc. Traditionally, digital twins have been a necessity in civil engineering, avionics, and others where for example the integrity of a bridge could be tested and simulated across various scenarios to identify vulnerabilities, weaknesses, and mitigation strategies. More recently, digital twins have been introduced to the cybersecurity of digital systems where they can be tested in a more convenient manner with semi/automated strategies. There are currently no conventional system for the analysis of embedded systems and ECUs (e.g., in automotive vehicles) that can reconfigure and adapt to multiple ECUs, systems, and networks (and that supports use cases where vulnerabilities found in the digital twin are also present in the real predicate system with measurable confidence).

### SUMMARY OF THE INVENTION

An example of the invention comprises FPGA-based emulation approaches, which supports achieving the aims of a robust digital twin framework-including physical modeling, which has the potential to be particularly relevant to enhanced vulnerabilities detection in digital twin systems. In an example of the invention, additional observability measures and/or IP may be developed in FPGA to result in a higher level of detail and granularity of system operation, especially in real-time, that advances current limitations with CPU-based systems and JTAG.

An example of the invention may include a digital twin framework capable of characterizing ECUs and their vulnerability detection at multiple layers. The system may for example support one or more ECUs and engine types in an architecture-agnostic manner and the significance of referencing attacks based on a continuously expanding set of attack signature libraries representing the multiple layers of ECUs that are eligible for analysis.

An example of the invention may be used to emulate one or more types of embedded devices that are utilized, such as in automotive and/or critical infrastructure. An example of the invention may be used to rehost arbitrary binary files, such as to reverse design the hardware of a firmware.

An example of the invention may be used as a cloud-hosted system that includes FPGA, which may benefit operations in, for example, cybersecurity, artificial intelligence, machine learning and/or other areas.

An example of the invention may be used as an automotive ECU cloud, which may support software, software defined hardware, and/or hardware peripherals whose configurations may be automated and/or completely abstracted away from end-users.

An example of the invention may have one or more types of end users, including, but not limited to:
data scientists, who may acquire statistical data from simulations for analysis and development of assessments, supporting various roles and functions in data science requiring data input.
vulnerability analysis researchers, who may initiate and launch vulnerabilities analysis for reporting findings and triaging actions related to their findings.
reverse engineers, who may obtain useful reporting insights and details of binary analysis for red/purple-teams.
engine specialists, who may configure aspects of an embedded device (e.g., ECU engine-type parameters) in a no-code environment.
electrical specialists, who may design or troubleshoot embedded devices (e.g., ECUs) in FPGA during manufacturing, test, and other manufacturing and/or laboratory processes.
Cloud hosted FPGA: to our knowledge this technology does not exist and may be utilized in various forms to benefit various operations in cybersecurity, Artificial Intelligence and Machine Learning (AI/ML), and other areas.
Automotive ECU cloud: to our knowledge this technology does not exist and may support software, software defined hardware, and/or hardware peripherals whose configurations would be automated and completely abstracted away from end-users.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 depicts a high-level example of an embedded systems analysis system; and

FIG. 2 depicts an example architecture that supports physical and digital signal modeling.

### DETAILED DESCRIPTION

The words “exemplary” and/or “example” are used herein to mean “serving as an example, instance, or illustration.” Any embodiment described herein as “exemplary” and/or “example” is not necessarily to be construed as preferred or advantageous over other embodiments.

Further, many examples are described in terms of sequences of actions to be performed by, for example, elements of a computing device. It will be recognized that various actions described herein can be performed by specific circuits (e.g., Application Specific Integrated Circuits (ASICs), Field Programmable Gate Arrays (FPGA), Graphics Processing Units (GPU)), by program instructions being executed by one or more processors, or by a combination of both. Sequences of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. For each of the embodiments described herein, the corresponding form of any such embodiments may be described herein as, for example, “logic configured to” perform the described action.

### Terminology

For this specification, terms may be defined as follows:
Application Specific Integrated Circuits (ASICs)—An integrated circuit chip designed for a specific use rather than a general-purpose use.
Controller Area Network (CAN)—A vehicle bus standard designed to allow microcontrollers and devices to communicate with each other's applications without a host computer.
Central Processing Unit (CPU)—Main processor of a computing system that executes instructions of a computer program.
Digital Storage Oscilloscope (DSO)—As intended, represents any analog or digital oscilloscope to measure analog electronic signals including EMR.
Digital Twin—A model designed to accurately reflect a physical and/or digital system and/or its peripherals. For example, it may be a FPGA/SoC with peripherals and sensors.
Electromagnetic Radiation (EMR)—Energy propagated through space at a fixed velocity (e.g., infrared, ultraviolet, gamma rays, radio waves, etc.).
Electronic Control Unit (ECU)—An embedded system in automotive electronics that controls one or more of the electrical systems or subsystems in a car or other motor vehicle.
Embedded Systems (ES)—A combination of computer hardware and software designed for a specific function. They may also function within a larger system.
Field Programmable Gate Arrays (FPGA)—An integrated circuit that can be programmed or adjusted after manufacturing. In this specification, the term FPGA is used broadly to include any reconfigurable digital logic capable of emulating a system at a sufficient level of fidelity to preserve characteristics relevant to the analysis, and supports observability at a sufficiently low level (e.g., on the hardware layer) to allow emulation without negative impact. These include technologies such as CPLDs (Complex Programmable Logic Devices), adaptive computing systems, and digital signal processing (DSP) blocks.
Firmware (FW)—A class of computer software that provides the low-level control for a device's specific hardware. It may be in a complete or incomplete form.
Graphics Processing Units (GPU)—An electronic circuit designed to render and accelerate computer graphics and image processing by performing rapid mathematical calculations.
Hardware (HW)—The physical elements of one or more computing or electronic systems and peripherals.
Industrial Control Systems (ICS)—Electronic control system and associated instrumentation used for industrial process control.
Intellectual Property (IP)—Set of intangibles owned and legally protected by a company from outside use or implementation without consent. For example, it may be specific FPGA software.
Side Channel Attacks (SCAs)—A security exploit that uses extra gathered information or influences the program execution of a system by measuring or exploiting information inadvertently leaked by a system.
System-on-a-Chip (SoC)—A microchip with all necessary electronic circuits and parts for a computing or other electronic system.
Software (SW)—The programs and other operating information used by a computer.
Software Defined Radio (SDR)—As intended, any software-based system to measure analog electronic signals including EMR.

### 1) Example of the Embedded Systems Analysis System

An example of the invention supports automatically reconfiguring and adapting embedded systems (including for example various cyber-physical systems). It may be in a form factor available for non-experts to utilize in an effective manner, for example with a graphical interface, cloud deployments, automated (i.e., headless) operations, and handheld systems, among others. The system may be comprised of simulating ES experiences from references and/or known origins, such as (but not limited to) ES specifications and/or firmware. The system may simulate complete automotive systems and/or the physics of original systems. It may be capable of identifying weaknesses and/or vulnerabilities of embedded systems, devices that typically incorporate one or more microcontrollers, such as SoCs, Programmable Logic Controllers (PLCs), and Internet-of-Things (IoT) devices.

An example may be an ES modeling system, firmware build system (i.e., that may be useful when for example no firmware is available), and/or a SW/HW digital twin system that may be capable of analyzing and/or reporting attacks and/or anomalies at multiple layers etc. Layers may include, but are not limited to, physical, sub-system, and/or network, etc. The invention may include programmable hardware (e.g., FPGA) where enhanced visibility and/or observational strategies may be enabled, and/or may suggest and/or propose a system where physical ES may be modeled and/or characterized for their simulation in hardware and/or software.

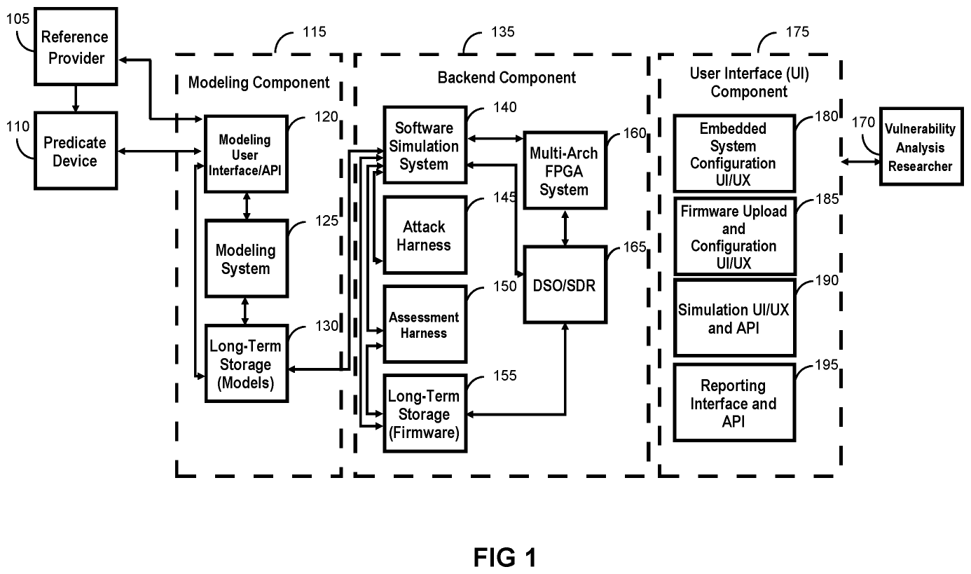

FIG. 1 depicts an example of the analysis system in an exemplary use case context for automotive cybersecurity, specifically vulnerability analysis of ECUs. Importantly, this example is not limited to this use case only, but can be used for many kinds of analysis and many kinds of systems (e.g., embedded or not embedded, including Operational Technology (OT), Industrial Control Systems (ICS), Information Technology (IT) devices, mobile devices, and/or any other device that includes at least some processing or physical modeling). Within the automotive vehicle use case, the analysis system is not limited to ECU components and devices, and can be used to create digital twins of other automotive systems to include Transmission Control Units, Powertrain Control Module, Body Control Module, infotainment systems, and telematics systems. The invention is not limited to FPGA as a technology component, and can be implemented with other suitable hardware and emulation mechanisms such as for example ASICs, CPUs, DPUs, GPUs, TPUs, and others.

An example of the analysis system includes a software-only interface with a software defined hardware backend that may include additional hardware (i.e., abstracted away from the end user of the system) in one or more forms, including but not limited to, peripherals, sensors, and/or daughter boards, etc. The analysis system's architecture may be a combination including, but not limited to, FPGA, peripherals, and/or optional analyzing (i.e., DSO and/or SDR, etc.) hardware that is intended to be hosted as a cloud-based service. In other words, the system results in a software-only interface where the hardware is abstracted away from users, very similar to modern cloud services where the hardware and/or servers are abstracted away from end-users.

An example of the analysis system is a hybrid system, which may include hardware and/or software simulation aspects by the needs of an input firmware device. In an example, rehosting firmware is required, since vulnerability/intrusion detection system may not be configured by an emulation purely from a top-down approach. For example, software-defined hardware, ES specifications, and firmware may be configured flexibly in a user interface, such as a low-code and/or no-code interface.

An embedded systems analysis system may have many benefits. An example of the analysis system may be designed to enhance observability (e.g., by orders of magnitude greater than the current state of the art). An example of the invention may advance the quality of assessments resulting from the enhanced observability of an embedded systems analysis system. An example of the invention may enhance observability of internal processes thanks to embedded systems emulations in FPGA. An example of the analysis system may help replicate and detect vulnerabilities with measurable confidence, and/or it may be used to analyze target embedded system(s) using their digital twin. An example of the invention may allow for modeling and/or designing of one or more embedded systems. An example of the invention may enable physical and/or digital modeling of signals, which may be used for vulnerability detection. It may include firmware rewriting, which may be useful to characterize physical signals of reference devices. An example of the analysis system may include automated peripherals management and/or configurations, including (but not limited to) memory mapping of devices.

While the described example use case focuses on analyzing embedded systems, the system's utility is not limited to conventional embedded systems. The invention is designed to be applicable to and compatible with a broad range of computing platforms or devices, including laptops, desktops, and servers.

### Enhanced Observability

In an example of the analysis system, the system may also be capable of dynamic analysis of programs, functions, algorithms, etc., optionally facilitated by observability IP. This system may be adaptable to both existing and emerging hardware architectures, including advanced CPUs such as RISC-V, which may incorporate observability features. Furthermore, the system may be capable of leveraging customized hardware solutions, such as SoC equipped with custom-configured FPGAs with observability IP. This observability IP may be essential for monitoring internal processor occurrences, like the state of memory, bus operations, and real-time processing unit operations, thereby providing unprecedented insights during dynamic analysis.

Observability IP can be broadly understood as specialized hardware modules or software components embedded within or interfaced with FPGAs and SoCs to enhance the visibility into the system's internal operations. These components are designed to provide real-time monitoring and analysis capabilities, enabling deeper insights into the workings of the hardware at a granular level. Observability IP can include a wide range of functionalities, such as:

Performance Monitoring: Tools and modules that track the performance of various components within the hardware, such as clock speed, power consumption, and thermal metrics.

Logic Analyzers and Event Triggers: Embedded logic analyzers can capture and analyze data buses and control signals within the FPGA or SoC, allowing developers to trace the sequence of operations and understand the cause and effect within the system. Event triggers can be set with conditional logic to dispatch notifications when conditions or anomalies are encountered.

Pentesting Interfaces: Interfaces that allow developers to inject data, augment execution flow, and modify the state of memory, registers, and other internal resources. This is a benefit that can be captured with enhanced observability to create dynamic scenarios for detecting vulnerabilities in the system.

Security Monitoring: Modules specifically designed for monitoring unallowed and unusual memory access patterns, data bus access control, and attempts to bypass security controls.

Compatibility and Scalability: This capability is designed for adaption to both existing and emerging hardware architectures.

### Enhanced Disassembly and Decompilation Processes

In an example of the analysis system, the system may address the computationally intensive processes of disassembly and decompilation. These processes may be essential for analyzing and understanding the structure and functionality of binary files of various architectures. The present system can realize significant improvements in the output quality of these processes, particularly in deriving buildable C code or an equivalent product. Such enhancements may be achieved through the application of advanced statistical and probabilistic methods, such as AI/ML techniques. The higher quality decompilation and/or disassembly product(s) may benefit the system to perform more accurate and efficient analysis, thereby contributing to higher quality outcomes and performance, such as a reduction in false positives and the ability to target individual functions, respectively.

### Cross-Architectural Rehosting

In an example of the analysis system, a novel cross-architectural rehosting system plays a central role. This involves the lifting of an input binary file from its original architecture and enabling its compilation to a different architecture. This transformation allows the execution and analysis of the binary file on a rehosting device that can operate on a rehosting device, possibly with a different architecture as the input binary file. The result of the transformation allows for the execution of the input binary file on a rehosting device, across multiple architectures. This capability is especially pertinent when the architectures of the binary file and the rehosting device are different.

In an example of the analysis system, data extracted from a predicate device can support and inform this execution process. Additionally, the rehosting device can be equipped with enhanced observability, such as the previously mentioned FPGA with observability IP, to enhance its analytical capabilities. The result of rehosting with observability IP provides insight into the internal operations of the rehosting device, facilitating new possibilities for researchers in binary analysis and vulnerabilities detection, among other use cases.

### Extended Analytical Capabilities

In addition to its functions in binary analysis and vulnerabilities detection, an example of the analysis system is also adept at supporting a wide array of other analytical tasks, for example analysis on devices with or without enhanced observability features or rehosting on various device types. This versatility may be a key attribute of the system, enabling it to be utilized in diverse contexts and for various purposes.

Performance Analysis: The analysis system may be capable of conducting detailed performance analysis. This involves assessing the efficiency and speed of software operations, both in its native environment and when rehosted in different architectures. Performance metrics can be gathered and analyzed, providing insights into aspects like response times, throughput, and processing efficiency.

Scalability Analysis: Scalability analysis is another aspect may be supported by the analysis system. It can evaluate how software behavior changes with varying load conditions or when scaled up to operate on larger or more complex systems. This may be particularly valuable for understanding the limits and potential of software in growing or evolving operational environments.

Resource Usage Analysis: The analysis system may also facilitate resource usage analysis. This can include monitoring and evaluating the consumption of computational resources such as CPU, memory, and storage, both under normal and peak load conditions. Such analysis can be used to optimize software performance and ensure efficient resource allocation.

Static Analysis for Preemptive Vulnerability Detection: The analysis system may enhance static analysis capabilities by leveraging its advanced disassembly and decompilation processes. When scrutinizing binary files without execution, these processes enable a more thorough and accurate analysis of the code in its inert state. This enhanced examination contributes to the identification of potential vulnerabilities, such as coding flaws, insecure practices, and deviations from compliance standards, with a reduction in false positives and false negatives.

Dynamic Analysis for Enhanced Real-Time Vulnerability Identification: The analysis system's dynamic analysis capabilities may be notably advanced due to its specialization in rehosting environments and enhanced observability features. By executing binary files in this controlled environment, the system can actively monitor and analyze software behavior as it unfolds in real time. This approach significantly benefits the detection of vulnerabilities that manifest during runtime, such as memory leaks, buffer overflows, and other execution-based anomalies. The strength of the system in dynamic analysis can be its ability to provide detailed, real-time observations of software interactions with hardware, memory, and other system components. The enhanced observability of rehosting device hardware, such as introspection into memory modules or buses and real-time outputs of processing unit activities, offer a level of detail and insight not currently available elsewhere. These capabilities enable the system to identify, analyze, and address complex runtime vulnerabilities more effectively, reducing the likelihood of overlooking critical issues that could lead to security breaches.

Targeted Analysis through Functional Decomposition and Rehosting: Targeted analysis may be yet another aspect supported by the analysis system, enabled by the decomposition of lifted binary files into discrete functions and algorithms that can be compiled and rehosted on analysis devices. This approach allows in-depth examination of specific software components that can be specified and targeted by end-users through configurations, API, user interfaces, etc. The system can efficiently assess key aspects of interest for purposes such as compliance, functionality, and performance against predefined specifications. This targeted analysis can streamline binary analysis to a filtered set of targets, resulting in improvements to the speed and depth of evaluations to save time and costs resulting from computational needs.

Extended Analyses: The analysis system may also equipped to handle analyses in domains such as fault tolerance to evaluate resilience and recovery mechanisms in the face of errors or failures, interoperability with other systems or components, and compliance checks such as mappings to industry standards such as NIST 800-53 to ensure the binary file under analysis meets necessary criteria.

Custom Analyses: The analysis system's modular design may allow for the integration of custom analysis modules via configurable API. Custom analyses comprise any assessment for any purpose that results from the analysis of the system. This adaptability means that the system can be continuously evolved and enhanced to meet emerging analytical challenges and opportunities in various fields, use cases, and scenarios.

Within the broader scope of the invention, a notable embodiment encompasses a computer-implemented method tailored for the rehosting and analysis of binary files, irrespective of their originating architecture. This method entails several critical steps to ensure the successful rehosting and analysis of software constructs such as kernels, bootloaders, applications, libraries, or similar entities contained within a binary file. Initially, the system is configured to receive a binary file through a computing system interface. Following reception, the binary file undergoes disassembly by a processor, converting the binary into disassembled code.

To enhance the quality of disassembly, the disassembled code is then processed using a combination of statistical and probabilistic programs, including statistical AI/ML techniques, aimed at refining the disassembled output. This refined disassembled code is an improvement over contemporary methods such as probabilistic disassembly by its utilization of Deep Neural Networks (DNNs) and Large Language Models (LLMs). The improved quality disassembly is subsequently eligible for decompilation to yield decompiled code, which may undergo further processing via similar statistical or probabilistic programs, optimized for decompilation, to enhance its quality and compatibility with the rehosting hardware. The product of the improved decompilation is buildable programs and fragments of programs, such as individual functions and algorithms.

The rehosting process is facilitated by configuring rehosting hardware with advanced observability capabilities, incorporating specialized components such as dedicated FPGAs equipped with observability IP. This enables the rehosting of a compiled program-derived from the processed decompiled code-on hardware specifically designed to support the architecture of the rehosted software, thereby ensuring compatibility and operational integrity.

Once rehosted, the program or its components are executed on the rehosting hardware, allowing for an in-depth analysis facilitated by the hardware's enhanced observability features. These features provide introspection into the hardware processes and states, surpassing the limitations of conventional CPU analysis. The system further incorporates dedicated vulnerability assessment modules to subject the running program to adversarial actions or data, thus enabling dynamic analysis through methods such as fuzzing, directed at specific functions and algorithms based on predefined user specifications and requirements.

The method results in output data that encapsulates the results of the rehosting and dynamic analysis processes. This output data can be stored or presented in various forms, including but not limited to reports, signals, or logs, individualized for diverse use cases and scenarios.

Additionally, the rehosting process may leverage model data to simulate the operational context of a predicate device. This involves loading model data, which encapsulates the original behavior or output of the predicate device based on its operational characteristics, dependencies, and environmental interactions. Utilizing this model data, the rehosting environment is configured to closely mimic the operational context of the predicate device, ensuring that the rehosted program operates as if it were within the original environment of the predicate system. This simulation aids in preserving operational integrity by mitigating potential crashes, ensuring that the rehosted program receives expected data inputs such as peripheral sensor readings and I/O communications, thereby replicating its native operational conditions.

FIG. 1 depicts an example process of the analysis system which includes how multiple stakeholders may interact with each other. On the left side of the diagram is the Reference Provider 105, who may be the manufacturer, reseller, and/or stakeholder who handles the computing device(s) (in this case, it may be the stakeholder who may be handling the computing device(s) on a vehicle), and on the right side of the diagram may be the Vulnerability Analysis Researcher 170 interacting with the system. A Modeling Component 115, Backend Component 135, and User Interface Component 175 are designed to be flexible, and may function and/or be provided independently or together (and may be present or not present, and there may be multiple).

### 1.1) Reference Provider

A Reference Provider 105 may provide information relating to one or more Predicate Device(s) 110, such as (but not limited to) firmware, hardware specifications, IP, digital and/or physical signals, device metadata, and/or other information, etc., to a Modeling Component 115. A Reference Provider 105 may include, but is not limited to, a manufacturer, partner, reseller, and/or other stakeholder, etc. For automotive embedded systems, a Reference Provider 105 may for example be an ECU manufacturer.

### 1.2) Predicate Device

A Predicate Device 110 may be one or more reference devices that may be modeled and/or simulated and/or made available for analysis downstream. For example, a Predicate Device 110 may be an automotive device. It may have one or more connections, such as but not limited to a CAN bus, I2C, SPI, UART, and/or discrete digital I/O. It may have one or more peripherals that comprise a Predicate Device 110 that may be able to run downstream. Predicate Device 110 data, which may include outputs collected from a Predicate Device 110, may be provided to a Modeling Component 115.

Predicate Device 110 data may include digital and/or physical characteristics and dimensions captured such as for example power draw, and/or consumption etc. It may include other peripherals, which may be connected to the device, which may be used to capture Predicate Device 110 data. For example, it may include but is not limited to Digital Storage Oscilloscopes (DSOs), which may be used to capture electromagnetic outputs from different parts of one or more Predicate Devices 110 and/or store them in memory. Predicate Device 110 data may come from the processor, memory, and/or storage, etc. Other characteristics may be observed and be provided, such as but not limited to, power use of components, connections to peripherals, and/or communication patterns, etc.

### 1.3) Modeling Component

A Modeling Component 115 is a software component that translates data that may be acquired via the one or more Reference Providers 105, such as ECU manufacturers or partners, to data structures for example for processing, analysis, and storage of physical and/or digital signals. These signals may be used for characterization, for example where normal operations are defined to identify ranges outside of normal during analysis, and high-fidelity emulation, for example where digital values of a component can be mocked or stubbed during running operations of the corresponding digital twin. Therefore, this component may be used to provide and/or define a baseline of behavior of a system with physical and/or digital characteristics. Signals received may define the primary dependencies of a functional emulation for the collection of digital twins, each representing a distinct automotive ECU system. A Modeling Component 115 may contain one or more Modeling User Interface/API 120, Modeling System 125, and/or Long-Term Storage (Models) 130, etc. There may be other modules not depicted in FIG. 1 which may be included in a Modeling Component 115.

### 1.4) Modeling User Interface/API

A Modeling User Interface/API 120 may include one or more mechanisms in which a user may communicate with a Modeling Component 115. It may include, but is not limited to, a web interface, a mobile application, a handheld device, and/or an API, etc. It may enable a user to provide signals and/or Predicate Device 110 data. A Modeling User Interface/API 120 may allow one or more Predicate Devices 110 to become part of a Modeling System 125.

### 1.5) Modeling System

A Modeling System 125 may include a pipeline where the baseline characterizations and/or modeling of Predicate Devices 110 may be available for analysis downstream. Downstream analyses may include, but are not limited to, vulnerability analysis. It may be designed to support physical and/or digital signal modeling and/or characterization. For example, physical modeling may be acquired from an outside source, such as from one or more Predicate Devices 110. It may utilize artificial intelligence and/or reinforcement learning to fill in gaps in signals that may not have been provided and/or recorded. It may utilize artificial intelligence and/or reinforcement learning to predict aspects of the system for modeling based on prior knowledge. A Modeling System 125 may emulate the original system, and/or it may analyze against the actual system.

Outputs of a Modeling System 125 may include, but are not limited to, for example, model, simulation, emulation, digital twin, and/or artificial intelligence model, etc. Outputs may be provided to Long-Term Storage (Models) 130 for lookup and/or use at a later time.

### 1.6) Long-Term Storage (Models)

Digital and physical signals may be modeled in a Modeling System 125, and these models can be stored in Long-Term Storage (Models) 130. This may act as a “Model Anthology” wherein models may be retrieved at a later time to develop digital twins and/or perform for example vulnerability analysis of embedded systems simulations. A Backend Component 135 may be able to utilize stored models for their role in vulnerability analysis and detection.

### 1.7) Backend Component

A Backend Component 135 may run a program in a digital twin environment, hardware and/or software, and/or be made up of one or more devices and/or peripherals. It may be provided full or partial software and/or firmware, etc. The backend may modify the input, wherein it may create multiple versions of the program to run on a simulated device. It may execute one or more inputs on multiple simulated devices. For example, it may have access to reference values from a prior model from the Model Component 115, which may have information on a system's normal working behavior. As an example, an Assessment Harness 150 may detect unexpected spikes in signals, which may compare against reference values. Information may be received from a User Interface Component 175 to a Backend Component 135 to provide context for simulation.

### 1.8) Software Simulation System

A Software Simulation System 140 may load and/or simulate software and/or peripherals on to an embedded system digital twin. It may receive a program to load and/or execute on an embedded system digital twin. It may capture signals of operation from the various components of the digital twin, including, but not limited to, observability IP to obtain internal processing signals, bus signals, and/or state of memory, etc. For example, it may utilize techniques such as reinforcement learning and/or artificial intelligence to train a digital twin to behave functionally identical to a real predicate ECU on certain layers (e.g., CAN bus behavior). A Software Simulation System 140 may support automated and/or semi-automated vulnerability analysis and/or detection, which may be performed in an Attack Harness 145 and/or Assessment Harness 150, etc. It may output an embedded system digital twin, which may be used in downstream analyses.

A Software Simulation System 140 may include a firmware build system. Known and/or unknown, or a combination, of firmware may be configured and/or built. Based on the embedded system and its known and/or unknown peripheral pattern, the system may self-heal and be able to rehost the firmware. This means that it may be able to simulate on a Multi-Arch FPGA System 160. This may enable a previously incomplete system and/or simulation to be simulated in totality, which may allow for full observability and/or analysis of an embedded system.

A Software Simulation System 140 may include an API, instrumentation, monitoring, and/or interactivity, etc. An API may allow operator interactions with the digital twin, such as an ECU digital twin. Instrumentation may be used to instrument code to, for example, measure how long it takes to run a function and/or add logging, etc. Monitoring may happen at the system level, such as (but not limited to) power usage, CPU usage, etc. Interactivity may be used to assess interactions of a digital twin. For example, interactivity in an ECU digital twin may include assessing braking in an anti-lock braking system.

### 1.9) Attack Harness

An Attack Harness 145 contains a suite of attacks that may be generated by the backend. It may probe and/or attack the embedded system digital twin, such as an ECU. An Attack Harness 145 may be used in both autonomous and semi-autonomous situations (or may be used to support manual attacks). Attacks may include, but are not limited to, pen-testing, reconnaissance, denial-of-service, fuzzing and/or injection, etc. For ECUs, CAN bus signals may be acquired from an ECU digital twin or modified through attacks, such as (but not limited to) eavesdropping, injection, and/or flooding attacks. An Attack Harness 145 may interface with an embedded system digital twin in one or more ways (e.g., SSH, API, interface, port etc.). For example, an Attack Harness 145 may attack one or more layers of an ECU digital twin, and/or it may carry out one or more modes of attacks.

Attack specifications may be provided by a user. An Attack Harness 145 may be accessed through available interfaces, such as (but not limited to) an API and/or user interface (UI), and/or may be used to configure and execute one or more attacks.

An Attack Harness 145 may create variations of signals and/or software, etc. For example, it may modify firmware for example by embedding vulnerabilities, for example depending on the availability of source code, and/or use advanced techniques such as binary rewriting, and/or control flow integrity, etc. for example to develop control attack scenarios. These may be useful in characterization studies, vulnerability analysis, and/or vulnerability detection etc., such as (but not limited to) pattern-based analysis of physical/digital signals in Machine Learning (ML) in an Assessment Harness 150.

### 1.10) Assessment Harness

An Assessment Harness 150 may include one or more assessments to evaluate various aspects of an embedded systems digital twin from a Software Simulation System 140. Assessments may include, but are not limited to, heuristics-based, AI-based, reinforcement-learning based, and/or statistical-based assessments. The assessments may analyze various aspects as described above. Data for analysis may be obtained from a Multi-Arch FPGA System 160 as a stream from the enhanced observability that may allow the capture of physical characteristics and/or emanations available to an Assessment Harness 150.

Whenever physical signals (capture and/or analysis) are involved in the exemplary analysis system, an Assessment Harness 150 may make reference to Long-Term Storage (Models) 130 derived from the characterization stage. It may include a combination of software attacks and/or static and/or dynamic assessments etc. Assessments may be interfaced with an automated binary analysis system. Assessments may utilize results received from an Attack Harness 145.

For example, an Assessment Harness 150 may transfer knowledge of analysis results (e.g., vulnerabilities) found through research (e.g., vulnerabilities research) on an embedded system digital twin back to the real predicate embedded system which the digital twin was modeled on. The confidence whether a vulnerability translates back to the real predicate ES may be determined by the fidelity and realism of the embedded system digital twin. For example, an assessment may provide a predicted probability (e.g., confidence score about a vulnerability, confidence score that a vulnerability is also present in the predicate ES etc.) whether a result (e.g., vulnerability, exploit, error etc.) found in an embedded system digital twin may also be in the real predicate embedded system.

It may utilize for example reinforcement learning to improve assessments and/or their scoring over time. Mechanisms to fine-tune confidence scores over time include, but are not limited to, collecting data over time in bulk and/or using statistical approaches and/or reinforcement learning to learn and/or predict confidence scores, etc.

The results of an Assessment Harness 150 may be organized and/or provided as a report that may be used (e.g., in a maximally flexible manner) depending on the needs of the end-user, such as command and control (C&C) and/or data science teams, etc.

### 1.11) Long-Term Storage (Firmware)

Previously obtained firmware, and/or digital twins and/or their configurations, may be stored in a Long-Term Storage (Firmware) 155. The lookup mechanism of a Long-Term Storage (Firmware) 155 may be designed to optimize resource (e.g., cost and/or time etc.) usage. The lookup mechanism may maximize the utility of physical modeling for the purposes of vulnerabilities detection. The results of analyses may be stored in long-term storage and/or may be made available for reporting and/or outputs.

### 1.12) Multi-Arch FPGA System

A Multi-Arch FPGA System 160 of for example a multi-processor system on chip (MPSoC) may obtain a bitstream that may have been pre-designed (i.e., with an Embedded System Configuration UI/UX 180) and selected from Long-Term Storage (Firmware) 155 and/or over the network etc. An MPSOC may also store bitstreams for their immediate selection and/or access etc. FPGA emulation aspects may be covered in advance of arriving to a Multi-Arch FPGA System 160, and the remaining peripheral connections aspects may be automated in a hosted or local environment with a peripherals/hardware harness whereby peripherals may be selected and configured appropriately in an automated manner or by simulation of the peripheral either as an IP core in but not limited to FPGA, a stubbed or mocked interface API, customized kernels in the operating system, and/or virtual machine, etc. For example, a result may be an ECU digital twin that can rehost firmware.

The firmware may be flashed to FPGA and—in the exemplary automotive vehicle use case—the engine-type settings will be set in the software of the FPGA or TCL (Tool Command Language) interface. It may utilize System on Chip (SoC) and/or other processors to load and monitor the embedded system firmware. Examples of architectures that may be instantiated may include but are not limited to RISC-V, PowerPC, and/or Arm, etc., to simulate the target processor. ECU peripherals, for example, may include CAN, SPI, and/or I2C, etc. Multiple expansion ports for various daughter cards may provide physical layer hardware for any extra peripherals. A Multi-Arch FPGA System 160 may include additional hardware (i.e., abstracted away from the end user of the system) in the form of peripherals, sensors, and/or daughter boards, etc.

A Multi-Arch FPGA System 160 may reconfigure itself to become various different architecture types and/or mixed architecture types. A Multi-Arch FPGA System 160 may define, based on some known characterizations, a peripheral connection pattern and/or some of the aspects to make it possible to rehost the program under analysis.

A Multi-Arch FPGA System 160 may incorporate a TCL (Tool Command Language) interface, which may function similarly to a Domain-Specific Language (DSL) specifically tailored for FPGA programming. This feature may allow the user to translate their specifications to configurations that the FPGA can use to self-modify and make the system run.

### 1.13) DSO/SDR

The exemplary DSO/SDR 165 includes EMR detection by the inclusion of a digital storage oscilloscope (DSO) or software defined radio (SDR). The results may be combined with physical characteristics that are emanated by a Multi-Arch FPGA System 160 under assessment or under simulation that is captured by the DSO/SDR 165. The DSO/SDR 165 may read electromagnetic waves and/or process them so that they may be analyzed (e.g., digitize, normalize etc.). Examples include: Power analysis-based:
Ihone UID key retrieval: A power analysis attack on the iPhone involved measuring voltage across a shunt 122 resistor on an external board, inserted between the external power supply and the device. Using necessary invasive modifications to the PCB, the attackers successfully recovered the the 256-bit hardware-based user identifier (UID) key after analyzing 200 million traces through correlation analysis.
Instruction profiling: Msgna et al. (2014) analyzed power consumption traces from an Atmel ATMega163 by measuring voltage drop across a shunt resistor on the MCU. Profiling 11 instructions, they employed template analysis with dimensionality reduction. Using statistical models like k-Nearest Neighbour (kNN) and a multi-variate Gaussian probability distribution function, the method achieved recognition accuracy ranging from 66.78% to 100%.

### EM-Based:

ARM SCA: Leignac et al. (2019) compared TEE (Trusted Execution Environment) and REE (Rich Execution Environment) execution using EM emissions from a HiKey SBC with an ARM Cortex-A53 CPU (1.2 GHZ) running Android Oreo in the REE and Trustonic Kinibi as the TEE OS. Despite increased complexity in synchronizing the correlation power analysis attack, TEE vulnerability was observed. TEE AES key recovery required 6000 traces, while the REE needed 10,000 for the correct key hypothesis.

### Other Physical SCAs

Acoustic cryptanalysis: Genkin et al. (2014) illustrated the feasibility of RSA key extraction through acoustic cryptanalysis, targeting a Lenovo laptop with a smartphone in close proximity. Using a laboratory microphone setup and a Samsung Note II, they successfully recovered a 4096-bit key within one hour by exploiting audible and ultrasonic sound emanations from GnuPG's RSA implementation.
Hutter and Schmidt (2013) demonstrated information leakage from an 8-bit AVR ATmega162 MCU by monitoring its temperature with a PT100 sensor (100 ms thermal response). Using the move (mov) instruction as a proof of concept, they observed noticeable temperature increases during a 20-second period based on the Hamming weight of processed values. The attack is suitable for simple devices with long-running operations and low-frequency signatures on a single thread of execution, although a full key recovery attack was not demonstrated.

### 1.14) Vulnerability Analysis Researcher

A user and/or system, which may be a Vulnerability Analysis Researcher 170 may provide information to a User Interface Component 175 to configure an embedded system digital twin, which may utilize prior known and/or uploaded models. A Vulnerability Analysis Researcher 170 may have software and/or firmware they want to run on the embedded system. A Vulnerability Analysis Researcher 170 may be samples of firmware or the full firmware. Example roles and uses cases may include vulnerability analysis researchers, reverse engineers, and/or automotive specialists, etc. to configure ECUs according to engine types, and/or a no-code FPGA design interface, etc.

### 1.15) User Interface Component

A User Interface Component 175 may include one or more user interface (UI) and/or user experience (UX), or UI/UX, components. A User Interface Component 175 may be easy to use and/or support a flat learning curve based on, for example, a user's technical expertise. It may have designs for specific user groups and types. It may be in a low-code and/or no-code format, GUI, textual, and/or interactive etc.

Each component may be dedicated to one or more functions of the system. The UI/UX components in the analysis system may include, but are not limited to, any combination of the ones depicted in FIG. 1: Embedded System Configuration UI/UX 180, Firmware Upload and Configuration UI/UX 185, Simulation UI/UX and API 190, and Reporting Interface and API 195. Other user interfaces may be specific to the use case it is being used for. For example, there may be a specific UI/UX component for analyzing a device in a warehouse environment.

### 1.16) Embedded System Configuration UI/UX

An Embedded System Configuration UI/UX 180 may enable Vulnerability Analysis Researchers 170 to configure an embedded systems digital twin, and/or its peripherals, such as but not limited to an ECU and/or engine configuration. For example, an Embedded System Configuration UI/UX 180 may define the type of engine (e.g., four-cylinder piston engine) and/or its firing order. For example, an Embedded System Configuration UI/UX 180 may specify the type of vehicle that would be running the predicate device. An Embedded System Configuration UI/UX 180 may specify the type of environment that would be running that embedded device. An Embedded System Configuration UI/UX 180 may be used for designing and/or selecting for emulation in FPGA.

### 1.17) Firmware Upload and Configuration UI/UX

A Vulnerability Analysis Researcher 170 may use a Firmware Upload and Configuration UI/UX 185 to configure and/or provide firmware for analysis with the digital twin. Through a Firmware Upload and Configuration UI/UX 185, a user may modify firmware by embedding vulnerabilities, depending on the availability of source code and/or using advanced techniques such as binary rewriting, control flow disruption, and/or weird machines, etc. These techniques that may be provided by a Firmware Upload and Configuration UI/UX 185 may be used to develop control attack scenarios against the software component of systems that are particularly useful in vulnerability analysis/detection, such as (but not limited to) by pattern-based analysis of physical/digital signals in ML.

A user may instantiate analysis of embedded systems. These may include developing and/or executing attacks and/or vulnerability analysis including, but not limited to, as alterations to normal signaling patterns and/or designing firmware/software attacks, etc.

The firmware may be stored in a Long-Term Storage (Firmware) 155. A Vulnerability Analysis Researcher 170 may modify received firmware and/or ask the program to modify the firmware, which enables the device to run different variations of a received program.

### 1.18) Simulation UI/UX and API

Users may interface with a Simulation UI/UX and API 190 for interacting with, configuring, and/or modifying a simulation, etc. A Simulation UI/UX and API 190 may interface with a Software Simulation System 140 API.

### 1.19) Reporting Interface and API

A Reporting Interface and API 175 may include retrieving reporting and/or output aspects of the Backend Component 135. Results may be available at various depths depending on the need of the recipients including, but not limited to, decision making, data science, software engineer, security engineer, analyst, vulnerability researcher etc.

### 2) Example of a Multi-Arch FPGA System

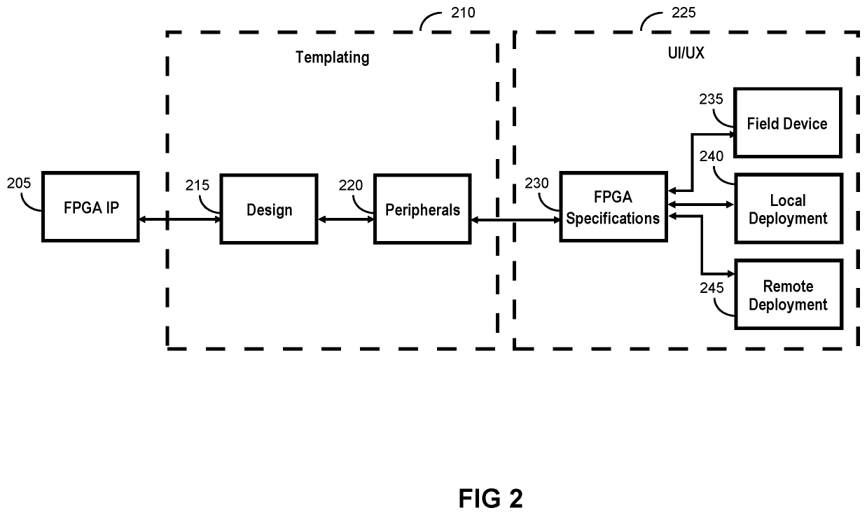

FIG. 2 depicts an example of a Multi-Arch FPGA System, wherein templates can be designed and/or generated for rehosting one or more architectures on a FPGA. It may include a list of known template FPGA IP 205, and/or a UI/UX 225 wherein FPGA components, known and/or unknown, may be specified and/or designed.

### 2.1) FPGA IP

FPGA IP 205 include architectures that have previously been utilized and/or are working. For example, FPGA IP 205 may be stored externally, but in other examples, it may be stored in Long-Term Storage (Firmware) 155 inside the embedded system analysis system. These consist of known architectures for devices and/or peripherals, etc. For example, known architectures may include, but are not limited to, AArch32, AArch64, RV32I, RV64I, and/or others. The FPGA IP 205 may be selected as a combination of multiple IP units to create digital twins of various devices, representing a combination of circuits, into a more unified representation.

### 2.2) Templating

Templating 210 is used for creating representations of devices, their peripherals, and/or their programs for analysis, etc. There may be different processors and different combinations.

There may be a mechanism to make a best guess or best fit in instances where not all architectures, devices, and/or peripherals are known. A reinforcement learning system may be used to autonomously redesign the system for example based on the results of iterative runs during instances where a program fails due to peripheral dependencies. Templating 210, including its autonomous units, may have access to FPGA IP 205, list of Peripherals 220 including but not limited to IP, and combinations, and/or may learn over time how to deal with unknown architectures and/or peripherals.

### 2.3) Design

Designs 215 may include one or more known and/or isolated designs, and may include as whether a known or unknown kind of architecture is encountered. Designs 215 and Peripherals 220 may work together to build representations of full systems on one or more FPGAs.

### 2.4) Peripherals

Templating 210 may support known and/or custom Peripherals 220. The signals of peripherals may be known and/or they may be derived. Example peripherals include I2C, CAN, SPI, UART, Timers, and/or General Purpose I/O.

### 2.5) UI/UX

A UI/UX 225 may enable the creation, selection, and/or configuration of a device and/or its peripherals. A UI/UX 225 enables the selection of devices and/or peripherals that users may have previously configured. A UI/UX 225 may emulate different programs on the same emulated device. A UI/UX 225 may be deployed in a single-tenant and/or multi-tenant manner. Some or all of the complexities of templating and handling peripherals may be abstracted away from the user so that the user uploads a program or part thereof that can execute on a newly or previously configured rehosting device. In an example of the analysis system, the system rehosts a program or part thereof on FPGA. However, the invention is not limited in the type of rehosting device.

### 2.6) FPGA Specifications

FPGA Specifications 230 may include a list of options that may be used to configure one or more modules. When modules are configured in combination, they may result in a device that is emulated. FPGA Specifications 230 may be (but is not limited to) a simple screen to select one or more devices.

### 2.7) Field Device

A user may for example select the device type for a system that may become a single tenant Field Device 235. For example, a Field Device 235 may be a handheld device that a user may plug into a vehicle and run attacks on a vehicle and/or retrieve outputs. With a Field Device 235, a user may choose one or more devices to run a specific program. The representation to run a program may be saved in but not limited to a handheld environment. For example, the representation may be used to plug into a vehicle and simulate the actual device with the components it is connected to.

### 2.8) Local Deployment

A Local Deployment 240 may be a multi-tenant local environment. A Local Deployment 240 may be used as a local data center. There may be multiple instances of the application operating in a shared environment. A Local Deployment 240 may include one or more databases.

### 2.9) Remote Deployment

A Remote Deployment 245 may be but is not limited to a multi-tenant SaaS and/or Cloud remote environment. This may include but is not limited to Cloud environments (e.g., private, hybrid and/or public) etc. Each tenant's data may be separated or combined with other tenants. A Remote Deployment 245 may include one or more databases.

What is claimed is:

1. A computer-implemented method for analyzing software or firmware of one or more computing systems to assess security properties related to the one or more computing systems, the method comprising:
loading, via a processor, from a data storage, a memory, or via a communication, or via a user entry through a user interface, at least one predicate device input data comprising characteristics about at least one predicate device;
translating, via a processor, the at least one predicate device input data into at least one predicate device model data comprising data structures that describe characteristics or dependencies of the at least one predicate device input data relevant to the analysis;
determining, via the processor, from the data storage, the memory, or via the communication, or via the user entry through the user interface, at least one digital twin configuration data used to configure at least one digital twin environment to behave as similar as possible to the predicate device with respect to processing the at least one predicate device model data;
loading, via the processor, from the data storage, the memory, or via the communication, or via the user entry through the user interface, the at least one digital twin configuration data onto the at least one digital twin environment;
storing, via the processor, the at least one predicate device model data and/or the at least one digital twin configuration data in the memory;
instructing, via the processor, the at least one digital twin environment to configure itself to implement the loaded at least one digital twin configuration data;
determining, via a processor, from the data storage, the memory, or via the communication, or via the user entry through the user interface, at least one security analysis to be carried out on the at least one digital twin environment;
simulating, on the at least one digital twin environment, the at least one predicate device;
executing, via the processor, the at least one security analysis on the digital twin environment;
generating, via the processor, an output data describing the at least one result of execution of the at least one security analysis;
storing, via the processor, the output data pertaining to the at least one result in a memory; and
determining, via the processor, if the at least one result satisfies a predetermined condition, and if so, executing at least one action corresponding to the at least one result on the computing system.

2. The method according to claim 1, wherein the at least one characteristics of the at least one predicate device input data comprises at least one of digital characteristics, physical characteristics, electrical power consumption, electromagnetic radiation, temperature, acoustics, emanations, firmware, software, binary, code, communications, network traffic, vibration patterns, hardware configurations, sensor data, system logs, user interactions, environmental conditions, GPS data, timing information, power cycles, error codes, device states, signal integrity, memory usage, processor activity, interface interactions, cryptographic operations, protocol specifics, storage contents, peripheral status, execution patterns, energy efficiency metrics, thermal profiles, electromagnetic compatibility, and/or wireless signal characteristics.

3. The method according to claim 1, wherein the at least one predicate device comprises at least one of an embedded system, an industrial control system, a programmable logic controller, or a computing device.

4. The method according to claim 1, wherein translating the at least one predicate device input data into the at least one predicate device model data comprises at least one of normalizing, filtering, pre-processing, un-biasing, balancing, selecting, correcting, auto-completing, inferring, cleaning, cleansing, converting, aggregating, smoothing, enriching, deduplicating, validating, segmenting, classifying, clustering, feature extraction, dimensionality reduction, scaling, discretizing, encoding, hashing, anonymizing, tokenizing, parsing, segmenting, interpolating, extrapolating, normalizing, standardizing, categorizing, summarizing, visualizing, correlating, integrating, aligning, optimizing, decomposing, reconstructing, compressing, decompressing, encrypting, decrypting, modeling, simulating, predicting, projecting, forecasting, estimating, detecting anomalies, identifying patterns, understanding context, generating insights, deriving metrics, benchmarking, evaluating, validating, backtesting, cross-validating, deploying, monitoring, updating, iterating, refining, evolving, contextualizing, localizing, personalizing, customizing, or optimizing.

5. The method according to claim 1, wherein the at least one predicate device model data comprises at least one of datasets of characteristics, binary data, assembly data, source code data, firmware, firmware images, logs, sensor readings, configuration files, diagnostic data, network packets, system metrics, user commands, environmental data, performance counters, hardware states, software versions, update histories, error messages, authentication records, encryption keys, communication protocols, user interfaces, API calls, memory dumps, registry settings, device specifications, GPS data, time stamps, power consumption patterns, electromagnetic emissions, acoustic signals, temperature readings, vibration data, pressure measurements, light intensity data, chemical composition data, material properties, structural integrity data, flow rates, energy usage data, bandwidth utilization, signal strength, latency measurements, throughput data, load profiles, capacity metrics, efficiency ratings, reliability indicators, maintenance records, operational statuses, geometric data, kinematic data, dynamic system models, control algorithms, optimization parameters, simulation results, test results, calibration data, audit trails, incident reports, vulnerability assessments, threat intelligence, security breaches, forensic analysis data, recovery plans, usage patterns, or digital footprints.

6. The method according to claim 1, wherein determining the at last one digital twin configuration data comprises at least one of manually or semi-automatically determining by a user, automatically determining, determining based on the kind of predicate device model data, determining based on which digital twin configuration data is compatible with each other, or modeling of the predicate device.

7. The method according to claim 1, wherein the at least one digital twin configuration data comprises at least one of FPGA IP, intermediate representation (IP), system model data, data sheet, binary data, script, code, pinout table.

8. The method according to claim 1, wherein the at least one digital twin environment comprises at least one of FPGA, CPU, SOC, emulator, simulator, virtualization environment, LLVM, QEMU, computing device, embedded device, peripheral, power supply, sensor, actuator, communications module, printed circuit board, cable harness.

9. The method according to claim 1, wherein the at least one security analysis comprises at least one of power analysis, EM analysis, acoustic analysis, temperature analysis, processor execution analysis, memory analysis, control flow graph analysis, capturing emanations via DSO/SDR, network traffic analysis, firmware reverse engineering, software vulnerability analysis, cryptographic analysis, side-channel attacks, fault injection analysis, timing analysis, protocol analysis, authentication mechanism analysis, data integrity analysis, anomaly detection, intrusion detection, malware analysis, root cause analysis, code static analysis, dynamic analysis, penetration testing, fuzz testing, threat modeling, risk assessment, compliance testing, physical security analysis, incident response analysis, recovery strategies, resilience testing, security benchmarking, security auditing, configuration management analysis, dependency analysis, patch management analysis, access control analysis, authorization analysis, session management analysis, encryption implementation analysis, key management analysis, secure boot analysis, secure update analysis, API security analysis, IoT security analysis, automotive security analysis, industrial control system security analysis, smart grid security analysis, healthcare device security analysis, wearable device security analysis, mobile security analysis, cloud security analysis, virtualization security analysis, container security analysis, blockchain security analysis, artificial intelligence security analysis, machine learning model security analysis, quantum computing security analysis, operational technology security analysis, SCADA system security analysis, network segmentation analysis, firewall rule analysis, intrusion prevention system analysis, anti-malware solutions analysis, data loss prevention analysis, endpoint protection analysis, secure communication protocols analysis, DNS security analysis, email security analysis, web application security analysis, database security analysis, storage security analysis, backup security analysis, disaster recovery planning analysis, adversarial simulation, cyber threat intelligence analysis, third-party security assessment, vulnerability scanning, file upload security analysis, session hijacking prevention analysis, directory traversal prevention analysis, remote code execution prevention analysis, denial of service attack prevention analysis, distributed denial of service attack prevention analysis, man-in-the-middle attack prevention analysis, phishing attack prevention analysis, spear-phishing attack prevention analysis, ransomware defense analysis, botnet detection analysis, cryptojacking defense analysis, insider threat detection analysis, data anonymization techniques analysis, secure deletion techniques analysis, digital footprint analysis, online tracking prevention analysis, privacy by design strategies analysis, cybersecurity insurance analysis, or cybersecurity metrics.

10. The method according to claim 1, wherein simulating the at least one predicate device comprises at least one of executing the predicate device code on the digital twin environment.

11. The method according to claim 1, wherein executing the at least one security analysis comprises at least one of capturing emanations, capturing data, capturing communications, probing, injecting, sniffing, attacking, monitoring, logging, decrypting, encrypting, bypassing, replaying, emulating, simulating, fuzzing, scanning, auditing, testing, validating, verifying, reverse engineering, disassembling, decompiling, sandboxing, patching, hardening, securing, configuring, optimizing, tuning, benchmarking, stress testing, load testing, performance testing, resilience testing, fault injection, tampering, cloning, spoofing, eavesdropping, intercepting, blocking, filtering, analyzing, decoding, demodulating, modulating, synthesizing, emulating, virtualizing, containerizing, orchestrating, automating, scripting, deploying, updating, upgrading, backing up, restoring, recovering, erasing, wiping, disabling, enabling, restarting, rebooting, shutting down, isolating, quarantining, containing, deterring, detouring, alerting, reporting, visualizing, documenting, training, quantizing, adjusting, balancing, aligning, scaling, synchronizing, rewarding, or reinforcing.

12. The method according to claim 1, wherein the output data comprises at least one of robustness compromise, availability compromise, partial or full system crash, confidentiality breach, exfiltration, unauthorized disclosure, unauthorized modification, compromise of peripheral, compromise of communications, physical damage, denial of service, man-in-the-middle attack, replay attack, phishing, spear-phishing, SQL injection, cross-site scripting, buffer overflow, firmware tampering, side-channel attack, cryptographic attack, code injection, session hijacking, zero-day exploit, vulnerability exploit, password cracking, phishing, supply chain attack, insider threat, data leakage, spoofing, tampering with data in transit, unauthorized access to sensitive data, data integrity breach, espionage, sabotage, command and control, botnet involvement, advanced persistent threat attack, remote code execution, keylogging, credential stuffing, dictionary attack, brute force attack, cross-site request forgery, clickjacking, drive-by download, malware infection, ransomware attack, privilege escalation, rootkit installation, backdoor access, IoT botnet participation, DDoS amplification, infrastructure hijacking, API abuse, cloud breach, virtual machine escape, container breakout, network segmentation bypass, wireless network compromise, GPS spoofing, sensor spoofing, SCADA system manipulation, industrial espionage, operational disruption, software supply chain attack, safety system disablement, environmental control system manipulation, vehicle control system hacking, medical device compromise, critical infrastructure sabotage, IP theft, unauthorized network access, unauthorized system configuration changes, unauthorized application installation, unauthorized data extraction, unauthorized system control, manipulation of device functionality, manipulation of physical processes, manipulation of sensor data, bypassing security controls, evasion of detection systems, analysis report, user-readable analysis report, visualizations, suggestions, recommendations, scorecard, machine-readable analysis report, or API call.

13. The method according to claim 1, wherein the at least one action comprises at least one of presenting output data to a user, communicating output data to another machine, storing output data, triggering one or more notifications or alarms, blocking the functioning of the predicate device, or triggering automated remediation/hardening.

14. A computer-implemented system for analyzing software or firmware of one or more computing systems to assess security properties related to the one or more computing systems, the system comprising:
a processor; and
a memory storing a computer-executable program,
wherein when the computer-executable program is executed by the processor, the computer-executable program configures the processor to:
load, from a data storage, the memory, or via a communication, or via a user entry through a user interface, at least one predicate device input data comprising characteristics about at least one predicate device;
translate the at least one predicate device input data into at least one predicate device model data comprising data structures that describe characteristics or dependencies of the at least one predicate device input data relevant to the analysis;
determine, from the data storage, the memory, or via the communication, or via the user entry through the user interface, at least one digital twin configuration data used to configure at least one digital twin environment to behave as similar as possible to the predicate device with respect to processing the at least one predicate device model data;
load, from the data storage, the memory, or via the communication, or via the user entry through the user interface, the at least one digital twin configuration data onto the at least one digital twin environment;
store, the at least one predicate device model data and/or the at least one digital twin configuration data in the memory;
instruct, the at least one digital twin environment to configure itself to implement the loaded at least one digital twin configuration data;
determine, from the data storage, the memory, or via the communication, or via the user entry through the user interface, at least one security analysis to be carried out on the at least one digital twin environment;
simulate, on the at least one digital twin environment, the at least one predicate device;
execute the at least one security analysis on the digital twin environment;
generate an output data describing the at least one result of execution of the at least one security analysis;
store the output data pertaining to the at least one result in a memory; and
determine if the at least one result satisfies a predetermined condition, and if so, executing at least one action corresponding to the at least one result on the computing system.

15. The system according to claim 14, wherein the at least one characteristics of the at least one predicate device input data comprises at least one of digital characteristics, physical characteristics, electrical power consumption, electromagnetic radiation, temperature, acoustics, emanations, firmware, software, binary, code, communications, network traffic, vibration patterns, hardware configurations, sensor data, system logs, user interactions, environmental conditions, GPS data, timing information, power cycles, error codes, device states, signal integrity, memory usage, processor activity, interface interactions, cryptographic operations, protocol specifics, storage contents, peripheral status, execution patterns, energy efficiency metrics, thermal profiles, electromagnetic compatibility, and/or wireless signal characteristics.

16. The system according to claim 14, wherein the at least one predicate device comprises at least one of an embedded system, an industrial control system, a programmable logic controller, or a computing device.

17. The system according to claim 14, wherein the processor is configured to translate the at least one predicate device input data into the at least one predicate device model data by at least one of normalizing, filtering, pre-processing, un-biasing, balancing, selecting, correcting, auto-completing, inferring, cleaning, cleansing, converting, aggregating, smoothing, enriching, deduplicating, validating, segmenting, classifying, clustering, feature extraction, dimensionality reduction, scaling, discretizing, encoding, hashing, anonymizing, tokenizing, parsing, segmenting, interpolating, extrapolating, normalizing, standardizing, categorizing, summarizing, visualizing, correlating, integrating, aligning, optimizing, decomposing, reconstructing, compressing, decompressing, encrypting, decrypting, modeling, simulating, predicting, projecting, forecasting, estimating, detecting anomalies, identifying patterns, understanding context, generating insights, deriving metrics, benchmarking, evaluating, validating, backtesting, cross-validating, deploying, monitoring, updating, iterating, refining, evolving, contextualizing, localizing, personalizing, customizing, or optimizing.

18. The system according to claim 14, wherein the at least one predicate device model data comprises at least one of datasets of characteristics, binary data, assembly data, source code data, firmware, firmware images, logs, sensor readings, configuration files, diagnostic data, network packets, system metrics, user commands, environmental data, performance counters, hardware states, software versions, update histories, error messages, authentication records, encryption keys, communication protocols, user interfaces, API calls, memory dumps, registry settings, device specifications, GPS data, time stamps, power consumption patterns, electromagnetic emissions, acoustic signals, temperature readings, vibration data, pressure measurements, light intensity data, chemical composition data, material properties, structural integrity data, flow rates, energy usage data, bandwidth utilization, signal strength, latency measurements, throughput data, load profiles, capacity metrics, efficiency ratings, reliability indicators, maintenance records, operational statuses, geometric data, kinematic data, dynamic system models, control algorithms, optimization parameters, simulation results, test results, calibration data, audit trails, incident reports, vulnerability assessments, threat intelligence, security breaches, forensic analysis data, recovery plans, usage patterns, or digital footprints.

19. The system according to claim 14, wherein the processor is configured to determine the at last one digital twin configuration data by at least one of manually or semi-automatically determining by a user, automatically determining, determining based on the kind of predicate device model data, determining based on which digital twin configuration data is compatible with each other, or modeling of the predicate device.

20. The system according to claim 14, wherein the at least one digital twin configuration data comprises at least one of FPGA IP, intermediate representation (IP), system model data, data sheet, binary data, script, code, pinout table.

21. The system according to claim 14, wherein the at least one digital twin environment comprises at least one of FPGA, CPU, SOC, emulator, simulator, virtualization environment, LLVM, QEMU, computing device, embedded device, peripheral, power supply, sensor, actuator, communications module, printed circuit board, cable harness.

22. The system according to claim 14, wherein the at least one security analysis comprises at least one of power analysis, EM analysis, acoustic analysis, temperature analysis, processor execution analysis, memory analysis, control flow graph analysis, capturing emanations via DSO/SDR, network traffic analysis, firmware reverse engineering, software vulnerability analysis, cryptographic analysis, side-channel attacks, fault injection analysis, timing analysis, protocol analysis, authentication mechanism analysis, data integrity analysis, anomaly detection, intrusion detection, malware analysis, root cause analysis, code static analysis, dynamic analysis, penetration testing, fuzz testing, threat modeling, risk assessment, compliance testing, physical security analysis, incident response analysis, recovery strategies, resilience testing, security benchmarking, security auditing, configuration management analysis, dependency analysis, patch management analysis, access control analysis, authorization analysis, session management analysis, encryption implementation analysis, key management analysis, secure boot analysis, secure update analysis, API security analysis, IoT security analysis, automotive security analysis, industrial control system security analysis, smart grid security analysis, healthcare device security analysis, wearable device security analysis, mobile security analysis, cloud security analysis, virtualization security analysis, container security analysis, blockchain security analysis, artificial intelligence security analysis, machine learning model security analysis, quantum computing security analysis, operational technology security analysis, SCADA system security analysis, network segmentation analysis, firewall rule analysis, intrusion prevention system analysis, anti-malware solutions analysis, data loss prevention analysis, endpoint protection analysis, secure communication protocols analysis, DNS security analysis, email security analysis, web application security analysis, database security analysis, storage security analysis, backup security analysis, disaster recovery planning analysis, adversarial simulation, cyber threat intelligence analysis, third-party security assessment, vulnerability scanning, file upload security analysis, session hijacking prevention analysis, directory traversal prevention analysis, remote code execution prevention analysis, denial of service attack prevention analysis, distributed denial of service attack prevention analysis, man-in-the-middle attack prevention analysis, phishing attack prevention analysis, spear-phishing attack prevention analysis, ransomware defense analysis, botnet detection analysis, cryptojacking defense analysis, insider threat detection analysis, data anonymization techniques analysis, secure deletion techniques analysis, digital footprint analysis, online tracking prevention analysis, privacy by design strategies analysis, cybersecurity insurance analysis, or cybersecurity metrics.

23. The system according to claim 14, wherein simulating the at least one predicate device comprises at least one of executing the predicate device code on the digital twin environment.

24. The system according to claim 14, wherein the processor is configure to execute the at least one security analysis by at least one of capturing emanations, capturing data, capturing communications, probing, injecting, sniffing, attacking, monitoring, logging, decrypting, encrypting, bypassing, replaying, emulating, simulating, fuzzing, scanning, auditing, testing, validating, verifying, reverse engineering, disassembling, decompiling, sandboxing, patching, hardening, securing, configuring, optimizing, tuning, benchmarking, stress testing, load testing, performance testing, resilience testing, fault injection, tampering, cloning, spoofing, eavesdropping, intercepting, blocking, filtering, analyzing, decoding, demodulating, modulating, synthesizing, emulating, virtualizing, containerizing, orchestrating, automating, scripting, deploying, updating, upgrading, backing up, restoring, recovering, erasing, wiping, disabling, enabling, restarting, rebooting, shutting down, isolating, quarantining, containing, deterring, detouring, alerting, reporting, visualizing, documenting, training, quantizing, adjusting, balancing, aligning, scaling, synchronizing, rewarding, or reinforcing.

25. The system according to claim 14, wherein the output data comprises at least one of robustness compromise, availability compromise, partial or full system crash, confidentiality breach, exfiltration, unauthorized disclosure, unauthorized modification, compromise of peripheral, compromise of communications, physical damage, denial of service, man-in-the-middle attack, replay attack, phishing, spear-phishing, SQL injection, cross-site scripting, buffer overflow, firmware tampering, side-channel attack, cryptographic attack, code injection, session hijacking, zero-day exploit, vulnerability exploit, password cracking, phishing, supply chain attack, insider threat, data leakage, spoofing, tampering with data in transit, unauthorized access to sensitive data, data integrity breach, espionage, sabotage, command and control, botnet involvement, advanced persistent threat attack, remote code execution, keylogging, credential stuffing, dictionary attack, brute force attack, cross-site request forgery, clickjacking, drive-by download, malware infection, ransomware attack, privilege escalation, rootkit installation, backdoor access, IoT botnet participation, DDOS amplification, infrastructure hijacking, API abuse, cloud breach, virtual machine escape, container breakout, network segmentation bypass, wireless network compromise, GPS spoofing, sensor spoofing, SCADA system manipulation, industrial espionage, operational disruption, software supply chain attack, safety system disablement, environmental control system manipulation, vehicle control system hacking, medical device compromise, critical infrastructure sabotage, IP theft, unauthorized network access, unauthorized system configuration changes, unauthorized application installation, unauthorized data extraction, unauthorized system control, manipulation of device functionality, manipulation of physical processes, manipulation of sensor data, bypassing security controls, evasion of detection systems, analysis report, user-readable analysis report, visualizations, suggestions, recommendations, scorecard, machine-readable analysis report, or API call.

26. The system according to claim 14, wherein the at least one action comprises at least one of presenting output data to a user, communicating output data to another machine, storing output data, triggering one or more notifications or alarms, blocking the functioning of the predicate device, or triggering automated remediation/hardening.
